(19) United States
(12) Patent Application Publication
(10) Pub. No.: US 2005/0060825 A1
(43) Pub. Date: Mar. 24, 2005

(54) Clothes dryer lint cleaning brush

(76) Inventor: Stephen Hillenbrand, Concord, CA (US)

Correspondence Address: MICHAEL A. SHIPPEY, PH. D., 4848 LAKEVIEW AVENUE, SUITE B, YORBA LINDA, CA, 92886, US

(21) Appl. No.: 10/666,136

(22) Filed: Sep. 22, 2003

(51) Int. Cl. A46B 3/18; B08B 9/00

(52) U.S. Cl. 15/104.2; 15/206

(57) ABSTRACT

Clothes dryer lint cleaning brush with a rigid non slip handle, a semi rigid double twisted wire shaft and soft durometer bristles intertwined with the shaft. The handle is fixidly attached to one end of the shaft The bristles are constructed of low durometer polyester and are positioned longitudinally starting near the tip of the wire shaft and traversing the shaft approximately eleven inches toward the handle. The bristles are radially disposed and taper from approximately a seven eights of an inch diameter at its tip and one and one half inches at its opposite end closest to the handle. A preferred embodiment includes a low durometer plastic cap that covers the tip of the wire shaft so that the shaft tip does not damage a standard lint screen during the cleaning process.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cleaning brushes and more specifically to a clothes dryer lint cleaning brush.

Cleaning brushes of many kinds are well known. One type of brush construction involves twisting a pair of metal wires and, while the wire is being twisted, inserting a plurality of bristles at a ninety degree angle to the wire so that the bristles are formed in a radial fashion about the twisted wire shaft. This type of construction allows the user to bend the shaft as necessary to reach into cavities that are non linear.

One application for a cleaning brush of the construction just described is the removal of lint that collects on and around lint traps within standard clothes dryers.

One such design was proposed by Linnea Berger in her patent U.S. Pat. No. 5,560,069. Although her patent discloses a brush that has some ability to bend to conform to the non linear openings of standard lint traps, it does not have the ability to bend to conform to more extreme compound curved recesses that are found in some clothes dryers. Additionally, the bristles are not tapered to allow for more easy insertion into the lint trap. Also, the tip of the brush is not covered with a protective cap so the tip may damage delicate lint screens. Finally, the bristles of the Berger brush are formed of wire reinforced nylon rather than soft durometer polyester thereby having a greater ability to damage delicate filter screens.

### BRIEF SUMMARY OF THE INVENTION

The primary object of the invention is to provide a lint cleaning brush for clothes dryers that safely removes lint and hair that drier traps miss.

Another object of the invention is to provide a lint cleaning brush that attracts lint to it and holds it in place for removal.

Another object of the invention is to provide a lint cleaning brush that does not damage the lint screen of a standard clothes drier.

A further object of the invention is to provide a lint cleaning brush whose bristles maintain proper stiffness regardless of moisture level in the area to be cleaned.

Yet another object of the invention is to provide a lint cleaning brush whose handle is durable, non conductive and slip resistant.

Still yet another object of the invention is to provide a lint cleaning brush that can be adapted to configure to the lint storing cavities any type of clothes drier.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed clothes dryer lint cleaning brush comprising: a rigid non slip handle, a semi rigid double twisted wire shaft, said handle fixidly attached to one end of said wire shaft, said wire shaft being approximately twenty four inches long from the tip portion to the said handle portion. A plurality of radially displaced lint cleaning bristles intertwined with said twisted wire shaft, said bristles being constructed of low durometer polyester. Said bristles positioned longitudinally starting near the tip of said wire shaft and traversing said shaft approximately eleven inches toward said handle. Said bristles being radially disposed and tapering from approximately a seven eights of an inch diameter at its tip and one and one half inches at its opposite end closest to said handle. Said wire tip having a soft plastic cover to protect the interior surfaces of a standard clothes drier.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a partial exploded view of the tip of the invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

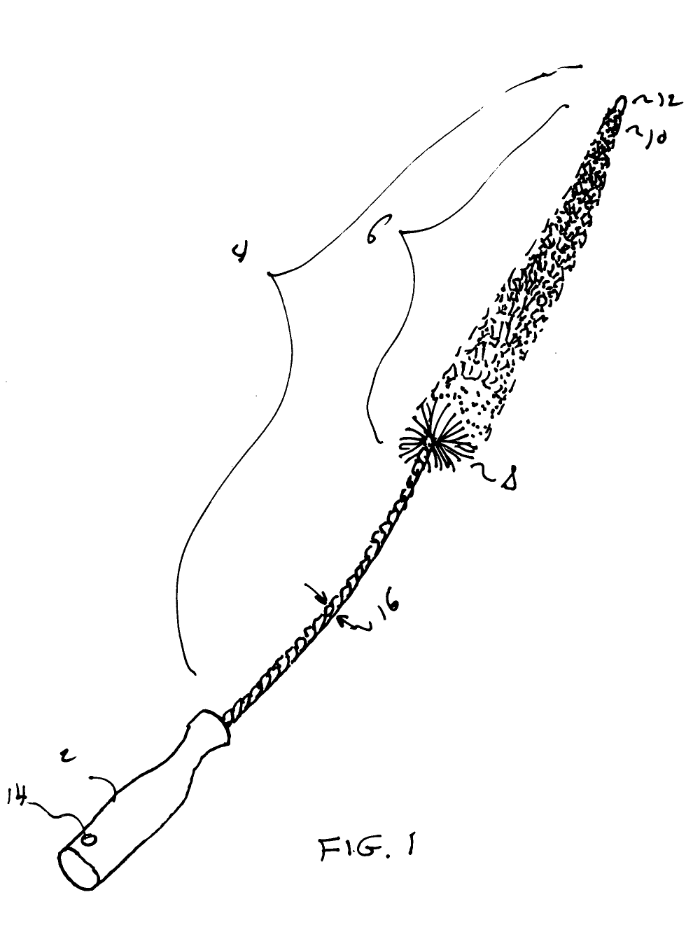

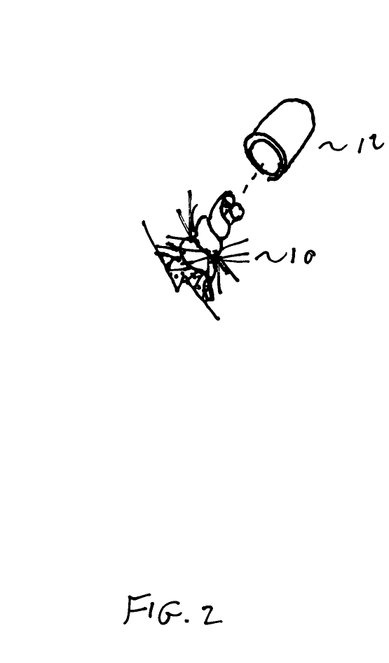

Referring now to FIG. 1 we see a perspective view of the lint cleaning brush of the present invention. The bristle part of the invention 6 is approximately eleven inches long and as a tapering radial diameter of approximately seven eights of an inch in diameter at the tip 10 to one and one half inches at its lower end 8. The taper allows the brush head to more easily enter and traverse the interior of standard lint traps found in standard clothes dryers. The bristles 6 are constructed of low durometer polyester S strand material and are rather densely packed when intertwined into the metal twisted wire shaft 4. The relatively soft bristles made as described above tend to draw in and removably retain lint and hairs that standard lint traps miss so that the lint can be safely removed from internal areas of a standard clothes drier. Additionally, the polyester material does not change in durometer when there are changes in humidity of moistue level thereby maintaining a consistent and efficient cleaning ability. The most effective bristles for this design are eight thousandths of an inch in diameter. My experiments show that the ideal length of the twisted wire shaft portion is twenty four inches from the tip of the bristles to the top of the handle 2 as shown by bracket 4. My experiments have shown that the ideal twisted wire diameter 16 is approximately three sixteenths of an inch, which is flexible enough to be bent to conform to various cavities in a standard clothes drier, but rigid enough not to buckle during the inward thrust of the lint cleaning tool described above. I have also found that it is important to cover the sharp tips of the twisted wire with a cap 12 that is shown in detail in the partial exploded view of FIG. 2. This cap prevents the wire tips from damaging the delicate lint trap screen and other components inside a standard clothes dryer.

The wire shaft portion 4 is fixidly attached to a handle member 2. The handle member is preferably made of wood for its durability and non slip characteristics. An aperture 14 in handle 2 allows the user to hang the lint cleaning brush on a hook or peg when not in use.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. clothes dryer lint cleaning brush comprising:
a rigid non slip handle;
a semi rigid shaft consisting of a pair of twisted metal wires;
said handle fixidly attached to one end of said wire shaft;
said wire shaft being approximately twenty four inches long from the tip portion to the said handle portion
a plurality of lint cleaning bristles intertwined with said twisted wire shaft;
said bristles being constructed of low durometer polyester;
said bristles positioned longitudinally starting near the tip of said wire shaft and traversing said shaft approximately eleven inches toward said handle; and
said bristles being radially disposed and tapering from approximately a seven eights of an inch diameter at its tip and one and one half inches at its opposite end closest to said handle.

2. Clothes dryer lint cleaning brush as claimed in claim 1 further a low durometer plastic cap that covers the tip of said wire shaft so that said shaft tip does not damage a standard lint screen during the cleaning process.

3. Clothes dryer lint cleaning brush as claimed in claim 1 wherein said bristles are constructed of semi-synthetic polyester S strand material that does not chang in stiffness regardless of humidity level

4. Clothes dryer lint cleaning brush as claimed in claim 1 wherein said bristles are spaced in close proximity to each other to allow said bristles to attract and removably retain lint.

5. Clothes dryer lint cleaning brush as claimed in claim 1 wherein said twisted wire shaft is approximately three sixteenths of an inch in diameter which is small enough to be easily bent by the user to conform to lint trap interiors but strong enough to be able to be pushed through the lint trap areas of a standard clothes drier without buckling

6. Clothes dryer lint cleaning brush as claimed in claim 1 wherein said handle is constructed of wood that is non conductive and non slip.

7. Clothes dryer lint cleaning brush as claimed in claim 1 wherein said lint brush assembly is inexpensive to manufacture.
